(19) United States
(12) Patent Application Publication
(10) Pub. No.: US 2025/0382841 A1
(43) Pub. Date: Dec. 18, 2025

(54) SHADING DEVICE

(71) Applicant: Grants Blinds Limited, Kent (GB)

(72) Inventor: Gaius Henry GUEST, Kungsbacka (SE)

(73) Assignee: Grants Blinds Limited, Kent (GB)

(21) Appl. No.: 19/234,386

(22) Filed: Jun. 11, 2025

(30) Foreign Application Priority Data
Jun. 18, 2024 (UA) 2408715.7

(51) Int. Cl. E06B 9/262; E06B 9/302; E06B 9/322

(52) U.S. Cl. CPC E06B 9/262; E06B 9/302; E06B 9/322; E06B 2009/2625

(57) ABSTRACT

A shading device for being arranged in association to a window includes an elongated guide rail arrangement that is adapted to be stationarily arranged relative to the window, an extendable covering, at least one elongated support member and a movement arrangement. The extendable covering is supported by the at least one elongated support member, wherein the at least one elongated support member is arranged to extend with its longitudinal direction in a transverse orientation relative to a longitudinal direction of the elongated guide rail arrangement and arranged to be movable along the elongated guide rail arrangement in the transverse orientation by the movement arrangement so that the extendable covering may be moved between a retracted state and an extended state for covering the window to different extents.

### BACKGROUND AND SUMMARY

The invention relates, according to an aspect thereof, to a shading device for being arranged in association to a window, wherein the shading device comprises an elongated guide rail arrangement that is adapted to be stationarily arranged relative to the window, an extendable covering, at least one elongated support member and a movement arrangement, wherein the extendable covering is supported by the at least one elongated support member, wherein the at least one elongated support member is arranged to extend with its longitudinal direction in a transverse orientation relative to a longitudinal direction of the elongated guide rail arrangement and arranged to be movable along the elongated guide rail arrangement in the transverse orientation by means of the movement arrangement so that the extendable covering may be moved between a retracted state and an extended state for covering the window to different extents.

The extendable covering is used to cover the window to, for example, manage sunlight, to provide insulation, blackout, to ensure privacy or security. Extendable coverings are usually on the interior side of windows, but exterior solutions are also available. Extendable coverings may also be referred to as window furnishings or window blinds. The extendable covering is arranged for movement between a retracted end state, in which it is substantially not covering the window, and an extended end state, in which it is covering the window completely or at least to a great extent.

One application of the invention is in specialist glazing areas, such as a room, typically in the form of a house extension or a separate building, or a roof lantern/skylight/dome in a normal room. Such a specialist glazing area may have a construction in aluminium or wood-based bars with panes of glass between the bars. The panes of glass may extend in both walls and the roof. The roof may have a curved shape forming a dome or similar.

It is known with a wintergarden shading system having two elongated side rails, that are arranged in a parallel relationship one on each side of the window. Each one of the rails has an elongated slot extending in a longitudinal direction of the rail. The rails are arranged so that the slots face each other. Further, a plurality of elongated support elements (rods) are arranged between the rails in an orientation perpendicular to the longitudinal direction of the rails, wherein the extendable covering in the form of a fabric or woven wood hang over the rods in a wave-like undulating orientation. Opposite ends of the rods are received in the slots of the rails. Further, the wintergarden shading system comprises a drive motor and elongated flexible elements operationally connected to the drive motor arranged inside the rails that are adapted to pull the extendable covering from a base where the motor is arranged. The rails may be curved to follow for example a curved glass roof. The arrangement of the elongated flexible element is hidden inside the rails and provides for an aesthetically attractive design.

For certain types of window shapes, such as windows that are tapering upwards from a base, such as triangular windows and tapering curved windows, an arrangement with parallel side rails is not feasible. For such an application, visible wires are used and the extendable covering hangs more like a sail. Further, there are arrangements where the extendable covering is pulled up with wires and follow a curved roof by the use of relieving rollers. Such an arrangement obstructs the view and changes the feel of the glass roof. There is a desire to preserve a curved glazing feature of a glass roof and achieve an aesthetically attractive design for shading devices for such more complex window shapes.

It is desirable to achieve an alternative shading device for a window with hidden wires for an aesthetically attractive design. It is especially desirable to achieve a shading device that creates conditions for covering a window with a shape that is tapering from a base.

According to an aspect of the invention, a shading device for being arranged in association to a window is provided, wherein the shading device comprises an elongated guide rail arrangement that is adapted to be stationarily arranged relative to the window, an extendable covering, at least one elongated support member and a movement arrangement, wherein the extendable covering is supported by the at least one elongated support member, wherein the at least one elongated support member is arranged to extend with its longitudinal direction in a transverse orientation relative to a longitudinal direction of the elongated guide rail arrangement and arranged to be movable along the elongated guide rail arrangement in the transverse orientation by means of the movement arrangement so that the extendable covering is moved between a retracted state and an extended state for covering the window to different extents, wherein the elongated guide rail arrangement comprises at least one housing defining at least one inner elongated chamber extending in the longitudinal direction of the elongated guide rail arrangement, a first slot and a second slot extending in the longitudinal direction of the elongated guide rail arrangement for forming a communication between one of the at least one inner elongated chamber and an outside of the elongated guide rail arrangement, wherein the first slot faces in a first lateral direction of the elongated guide rail arrangement and the second slot faces in a second lateral direction of the elongated guide rail arrangement that is opposite the first lateral direction, wherein the movement arrangement is at least partially arranged inside the at least one inner elongated chamber, wherein the at least one elongated support member is connected to the movement arrangement via said first slot and via said second slot.

Accordingly, the at least one elongated support member is connected to the elongated guide rail arrangement in two fixing points spaced apart in a transverse direction relative to the longitudinal direction of the elongated guide rail arrangement which creates conditions for a proper stability in operation.

This shading device creates further conditions for an extendable covering in the form of a fabric or woven wood that may hang over a plurality of elongated support members (rods) in a wave-like structure.

According to one example, the extendable covering forms a loop at one end, wherein the size of the loop is adapted for receipt of a first one of the elongated support members. In other words, the extendable covering may be formed in a flexible sheet, such as in fabric, wherein a free end of the flexible sheet may be curved back and attached to a main body of the flexible sheet by stitches thereby forming the loop.

According to one embodiment example, the at least one elongated support member is arranged in the transverse orientation so that a first portion of the elongated support member is arranged on a first lateral side of the elongated guide rail arrangement and a second portion of the elongated support member is arranged on a second lateral side of the elongated guide rail arrangement,

According to a further embodiment example, the at least one elongated support member is connected to the elongated guide rail arrangement in a centre region of the elongated support member in its longitudinal direction in a way that the first portion and the second portion of the elongated support member are substantially of equal lengths. It creates further conditions for a proper stability in operation.

Further, such a centred guide rail arrangement removes the need for side rails, and that enables shaped extendable coverings such as triangles. Further, it creates conditions for a curved guide rail arrangement for domes and other curved window structures, all with hidden wires. According to one example, the extendable covering may be arranged to follow a serpentine curve.

If applicable, such a centred guide rail arrangement is preferably arranged adjacent and in parallel with a bar in a wall or roof of a building so that the extendable covering may cover panes of glass on both sides of the bar. Arranging the guide rail arrangement so that it overlaps with the bar creates further conditions for an aesthetically attractive design in that the guide rail arrangement and the bar occupies a minimum of space laterally and may be perceived as a single unit.

According to a further embodiment example, the extendable covering is arranged symmetrically on either side of the elongated guide rail arrangement. It creates conditions for covering windows of a design that is symmetric with regard to a centre line, i.e. windows that are mirrored in the centre line.

According to a further embodiment example, the elongated guide rail arrangement comprises a first guide rail that comprises the first slot and a second guide rail that comprises the second slot, wherein the first guide rail and the second guide rail are arranged in parallel with each other. It creates conditions for using prior art side rails and arrange them adjacent each other in a back-to-back relationship. More specifically, according to one example, the first guide rail and the second guide rail are identical and arranged in a mirrored relationship.

Arranging the first guide rail and the second guide rail adjacent each other creates conditions for a guide rail arrangement that occupies a minimum of space laterally, which provides for an aesthetically attractive solution.

According to a further embodiment example, the first guide rail and the second guide rail are arranged rigidly attached to each other. Accordingly, the first guide rail and the second guide rail may be assembled as one unit to a wall or roof, which creates conditions for a facilitated assembly.

According to a further embodiment example, the shading device comprises a pair of arms associated to each one of the at least one elongated support member, wherein the arms extend in a transverse direction relative to the longitudinal direction of the elongated support member, wherein a first end of each arm is connected to the elongated support member and a second end of each arm is connected to the movement arrangement via the first slot and second slot, respectively. Accordingly, the arms define two fixing points spaced apart in a transverse direction relative to the longitudinal direction of the elongated guide rail arrangement which creates further conditions for a proper stability in operation.

According to a further embodiment example, the first end of each arm is connected to the at least one elongated support member by means of a clip that partially surrounds the at least one elongated support member. According to one example, the clip is adapted for a click-in connection. According to one example, the clip comprises two opposite legs that are adapted to flex away from each other for receiving the elongate support member/bar therebetween in assembly.

According to a further embodiment example, the extendable covering comprises a sheet of fabric that is connected to the at least one elongated support member. It creates conditions for a space-efficient design in the retracted state.

According to a further embodiment example, the at least one elongated support member is formed by a straight pin. According to one example, the pin has a constant cross section along its longitudinal direction. According to one further example, the pin has a circular shape in cross section.

According to a further embodiment example, the shading device comprises a plurality of elongated support members, and wherein each one of the plurality of elongated support members is arranged to extend in the transverse orientation relative to the longitudinal direction of the elongated guide rail arrangement and arranged to be movable along the elongated guide rail arrangement in a way that their interspacing may be changed from a first interspacing when the extendable covering is in the retracted state to a second interspacing when the extendable covering is in the extended state, wherein the second interspacing is larger than the first interspacing.

According to a further embodiment example, at least two of said plurality of elongated support members have different lengths. According to one example, the plurality of elongated support members have continuously shorter lengths from a base end of the extendable covering to a top end of the extendable covering, wherein the lengths and interspacing is adapted to match a certain tapering shape of the extendable covering. Thus, opposite ends of each one of the plurality of elongated support members may be arranged adjacent a boundary of the extendable covering.

According to a further embodiment example, the extendable covering is connected to a plurality of the movably arranged elongated support members at a set spacing in an extension direction of the extendable covering so that the extendable covering may be arranged in a generally plane configuration when the extendable covering is in an extended end state and in a folded/undulating configuration when the extendable covering is in a retracted end state.

According to a further embodiment example, the at least one housing comprises at least one wall portion that forms a front face and/or rear face of the guide rail arrangement, wherein the guide rail arrangement has a curved shape along at least one part of the guide rail arrangement in its longitudinal direction, wherein the movement arrangement comprises at least one elongated flexible element arranged in the inner elongated chamber of the housing and wherein the at least one elongated flexible element is adapted to be arranged in contact with an inner surface of the at least one wall portion in the curved part of the guide rail arrangement so that the elongated flexible element may slide along the inner surface during movement of the extendable covering between the retracted state and the extended state.

Accordingly, irrespective of the shape of the guide rail arrangement, the elongated flexible element will be hidden inside of the inner elongated chamber. Further, the elongated flexible element may be formed in a tough flexible material for transmitting motion.

According to a further embodiment example, the at least one elongated flexible element is formed by a continuous band that has a substantially even/smooth outer surface for sliding in contact with the inner surface of the at least one wall portion in the curved part of the guide rail arrangement.

According to a further embodiment example, the movement arrangement comprises a drive motor, at least one pair of wheels and at least one elongated endless flexible element, wherein the wheels in said at least one pair of wheels are arranged spaced from each other in the longitudinal direction of the guide rail arrangement, wherein the elongated flexible element is arranged in a loop around the wheels in said at least one pair of wheels, wherein the drive motor is adapted to rotate at least one of the wheels, wherein the at least one movably arranged elongated support member is operationally connected to the elongated flexible element. According to one example, the elongated guide rail arrangement is arranged at the window so that the drive motor is arranged below the window and a distant one of the wheels is arranged at the top of the window.

Further advantages and advantageous features of the invention are disclosed in the following description.

### BRIEF DESCRIPTION OF THE DRAWINGS

With reference to the appended drawings, below follows a more detailed description of embodiments of the invention cited as examples.

In the drawings:

FIG. 1 is an exploded perspective view of a shading device according to a first embodiment,

FIG. 2 is a perspective view of the shading device in FIG. 1 for arranging an extendable covering in a retracted state,

FIG. 3 is a perspective view of the shading device in FIG. 1 for arranging the extendable covering in an extended state,

FIG. 4 is a partly cut cross section view of the shading device in FIG. 1,

FIG. 5 is a perspective view of an attachment means for attachment to a transmission band in the shading device in FIG. 1,

FIG. 6a is a perspective view of the shading device in FIG. 1 with the extendable covering in the retracted state corresponding to FIG. 2,

FIG. 6b is a perspective view of the shading device in FIG. 1 with the extendable covering in the extended state corresponding to FIG. 3,

FIGS. 7a and 7b discloses an alternative design of the shading device in FIG. 1 in a retracted state and an extended state, respectively, corresponding to FIGS. 6a and 6b,

FIG. 8 is a perspective view of the shading device in FIG. 1 associated to a triangular window,

FIGS. 9a, 9b and 9c discloses a further alternative design of the shading device in FIG. 1 in different extension states,

FIG. 10 discloses a further alternative design of the shading device in FIG. 1, wherein the rail arrangement has a curved shape, wherein a plurality of elongated support elements are of different lengths,

FIG. 11 discloses an alternative design of the shading device in FIG. 10, wherein a plurality of elongated support elements are of equal lenghts,

FIG. 12 discloses an alternative design of the shading device in FIG. 10, wherein the rail arrangement has a serpentine shape,

FIG. 13a is a partly cut perspective view of a building in the form of a room with curved windows, wherein a number of shading devices according to the invention are provided in extended states,

FIG. 13b is a partly cut perspective view of a building in FIG. 13a, wherein a number of shading devices according to the invention are provided in retracted states, and

FIGS. 14a, 14b and 14c discloses the shading device in FIG. 1 in different extension states in cross sectional views.

### DETAILED DESCRIPTION

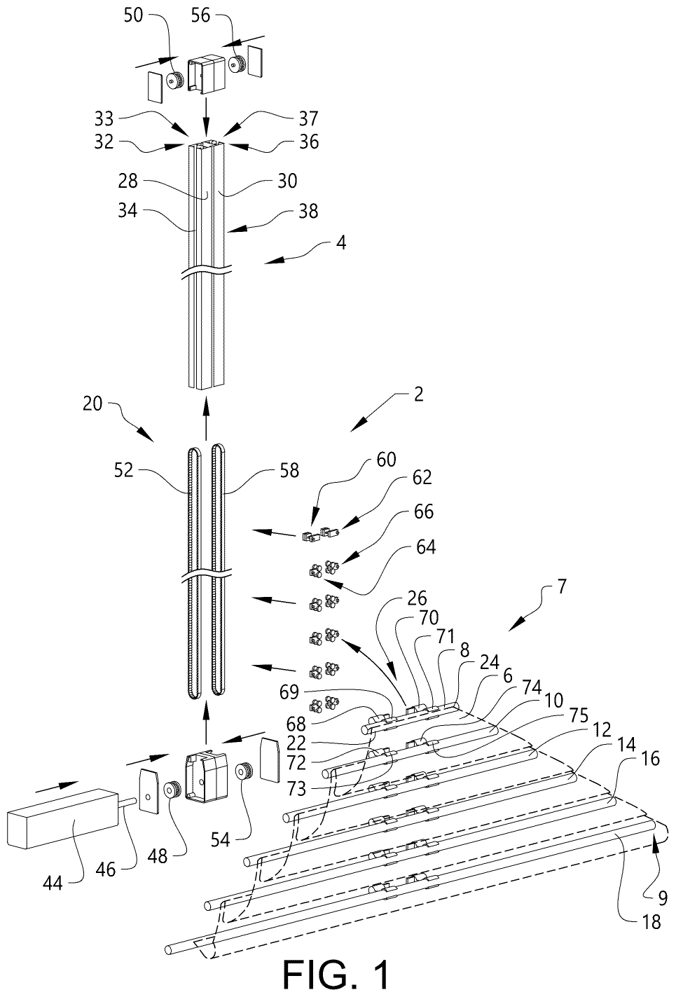

FIG. 1 is an exploded perspective view of a shading device 2 according to a first embodiment. The shading device 2 may alternatively be called a screen device. The shading device 2 comprises an elongated guide rail arrangement 4 that is adapted to be stationarily arranged relative to a window. The elongated guide rail arrangement 4 has a longitudinal direction along a straight line. The shading device 2 further comprises an extendable covering 6 in the form of a sheet of fabric. The shading device 2 further comprises a plurality of elongated support members 8, 10, 12, 14, 16, 18 in the form of straight pins. The extendable covering 6 is supported by the plurality elongated support members 8, 10, 12, 14, 16, 18. Each one of the elongated support members 8, 10, 12, 14, 16, 18 is arranged to extend with its longitudinal direction in a transverse orientation, and more particularly perpendicularly, relative to the longitudinal direction of the elongated guide rail arrangement 4. Thus, the plurality of elongated support members 8, 10, 12, 14, 16, 18 are arranged in parallel with each other. The shading device 2 further comprises a movement arrangement 20, wherein the elongated support members 8, 10, 12, 14, 16, 18 are arranged to be movable along the elongated guide rail arrangement 4 in the transverse orientation by means of the movement arrangement 20 so that the extendable covering 6 is moved between a retracted state and an extended state for covering the window to different extents.

A first one 8 of the elongated support members 8, 10, 12, 14, 16, 18 is arranged at a first end 7 of the extendable covering 6 in its extension direction and attached to the extendable covering 6. The first elongated support member 8 has a first length in its longitudinal direction. More specifically, the first length of the first elongated support member 8 matches a lateral extension of the extendable covering 6 at the first end 7 of the extendable covering 6. A second one 10 of the elongated support members 8, 10, 12, 14, 16, 18 is arranged adjacent the first elongated support member 8 and attached to the extendable covering 6 at a set distance along the extendable covering 6 from the first elongated support member 8. The second elongated support member 10 has a second length in its longitudinal direction that is longer than the first length of the first elongated support member 8. More specifically, the second length of the second elongated support member 10 matches a lateral extension of the extendable covering 6 at a distance from the first end 7 of the extendable covering 6. A further one 18 of the elongated support members 8, 10, 12, 14, 16, 18 is arranged at a second end 9 of the extendable covering 6 in its extension direction and attached to the extendable covering 6. The further elongated support member 18 arranged at the second end 9 of the extendable covering 6 in its extension direction has a greatest length of the elongated support members 8, 10, 12, 14, 16, 18. More specifically, the further elongated support member 18 has a length that matches a lateral extension of the extendable covering 6 at the second end 9 of the extendable covering 6. More specifically, the elongated support members 8, 10, 12, 14, 16, 18 have lengths that are continuously increasing between the first end 7 of the extendable covering 6 and the second end 9 of the extendable covering 6. Further, the elongated support members 8, 10, 12, 14, 16, 18 are attached to the extendable covering 6 at set distances, in this embodiment at equal interspacing in the extension direction.

Further, the elongated support members 8, 10, 12, 14, 16, 18 are arranged on a front side of the elongated guide rail arrangement 4. Further, the elongated support members 8, 10, 12, 14, 16, 18 have lengths that are substantially longer than a width of the elongated guide rail arrangement 4. More specifically, the first elongated support member 8 is arranged in the transverse orientation so that a first portion 22 of the first elongated support member 8 is arranged on a first lateral side of the elongated guide rail arrangement 4 and a second portion 24 of the elongated support member 8 is arranged on a second lateral side of the elongated guide rail arrangement 4 when seen in a front view. More specifically, the elongated support member 8 is connected to the elongated guide rail arrangement 4 in a centre region 26 of the elongated support member 8 in its longitudinal direction in a way that the first portion 22 and the second portion 24 of the elongated support member are substantially of equal lengths. The further elongated support members 10, 12, 14, 16, 18 are arranged relative to the elongated guide rail arrangement 4 in a similar fashion.

Further, the elongated support members 8, 10, 12, 14, 16, 18 are adapted in lengths for matching a width of the extendable covering 6. Accordingly, the extendable covering 6 has a design with lateral boundaries arranged symmetrically on either side of a centre plane that coincides with the elongated guide rail arrangement 4.

The elongated guide rail arrangement 4 comprises a first guide rail 28 and a second guide rail 30 that are arranged in parallel with each other. Thus, each one of the first guide rail 28 and the second guide rail 30 has a longitudinal extension along a straight line. The first guide rail 28 comprises a first housing 32 defining at least one inner elongated chamber 33 extending in the longitudinal direction of the first guide rail 28. The first guide rail 28 further comprises a first slot 34 extending in the longitudinal direction of the first guide rail 28 for forming a communication between the inner elongated chamber 33 and an outside of the first guide rail. The first slot 34 faces in a first lateral direction of the elongated guide rail arrangement 4. The first housing 32 has a generally rectangular cross section.

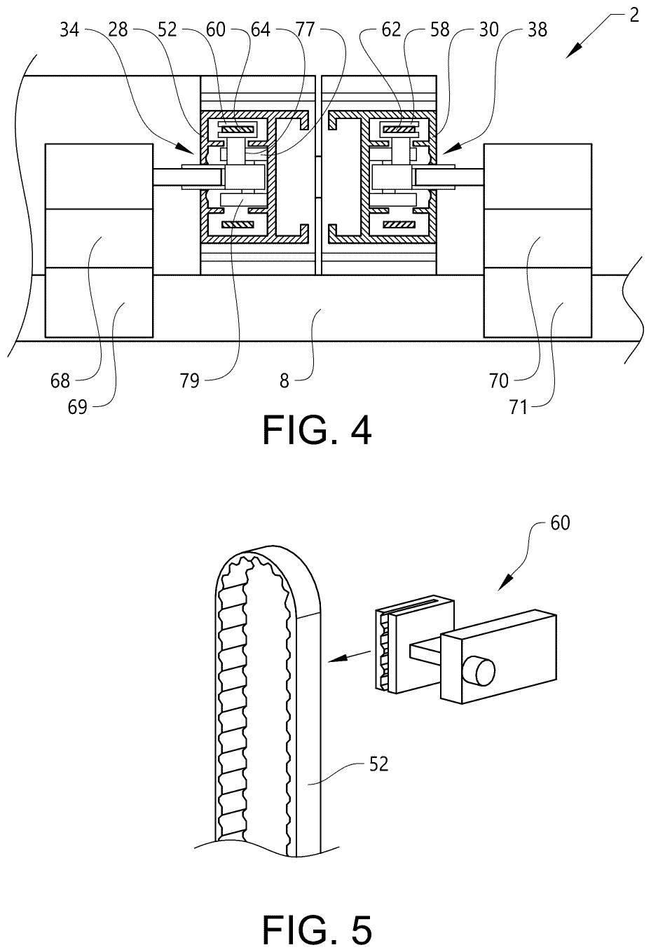

The second guide rail 30 comprises a second housing 36 defining at least one inner elongated chamber 37 extending in the longitudinal direction of the second guide rail 30. The second guide rail 30 further comprises a second slot 38, see FIG. 4) extending in the longitudinal direction of the second guide rail 30 for forming a communication between the inner elongated chamber 37 and an outside of the second guide rail 30. The second slot 38 faces in a second lateral direction of the elongated guide rail arrangement 4 that is opposite the first lateral direction. The second housing 36 also has a generally rectangular cross section.

The first guide rail 28 and the second guide rail 30 are in this embodiment identical and arranged in a back-to-back relationship so that the slots 34, 38 face in opposite directions away from each other. Further, the first guide rail 28 and the second guide rail 30 are arranged adjacent each other. Further, the first guide rail 28 and the second guide rail 30 are arranged rigidly attached to each other.

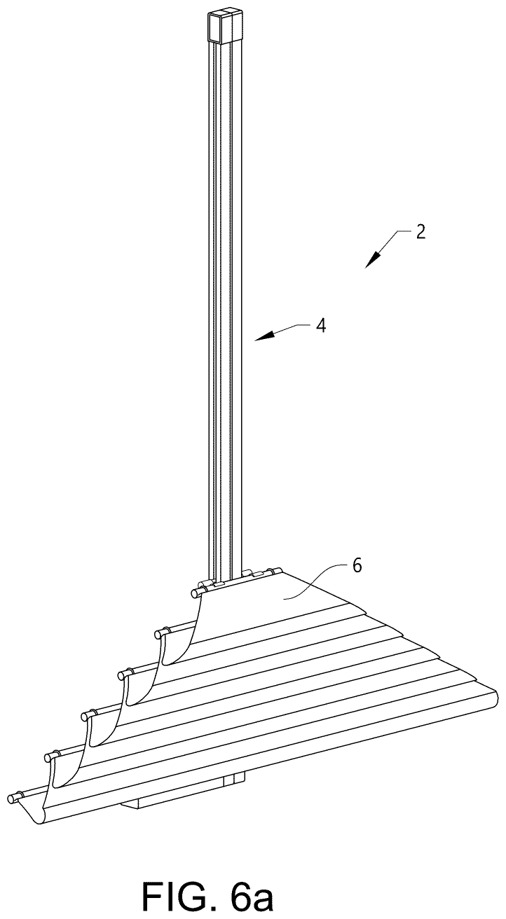

Turning now to the movement arrangement 20. The movement arrangement 20 comprises a drive motor 44 that has an output rotational shaft 46. The movement arrangement 20 further comprises a first pair of two wheels 48, 50, one wheel at each end of the first guide rail 28, and an endless elongated flexible element 52 that is operationally connecting the two wheels 48, 50. Accordingly, the endless elongated flexible element 52 is provided inside of the first housing 32. The movement arrangement 20 further comprises a second set of two wheels 54, 56, one wheel at each end of the second guide rail 30, and an endless elongated flexible element 58 that is operationally connecting the two wheels 54, 56. Accordingly, the endless elongated flexible element 58 is provided inside of the second housing 36. The arrangement of the wheels and the continuous elongated flexible element are identical in the first guide rail 28 and in the second guide rail 30, wherein a movement of the two continuous elongated flexible elements 52, 58 are synchronized so that they move in unison. More specifically, each one of the two continuous elongated flexible elements 52, 58 is formed by an endless band with a toothing, see FIG. 5, provided on an inner surface for engagement with an external toothing on its associated wheels 48, 50; 54, 56.

The elongated support members 8, 10, 12, 14, 16, 18 are connected to the elongated flexible elements 52, 58 so that the elongated support members 8, 10, 12, 14, 16, 18 may be moved in the longitudinal direction of the guide rail arrangement 4 by means of the movement arrangement 20. More specifically, the first elongated support member 8 is rigidly attached to the endless elongated flexible elements 52, 58 by means of a pair of spaced engagement members 60, 62. It will be further described below with reference to FIG. 4 and FIG. 5.

Each one of the further elongated support members 10, 12, 14, 16, 18 is connected to a pair of wheeled carriages 64, 66. Each one of the wheeled carriages 64, 66 is adapted to be arranged inside of the first housing 32 and the second housing 36, respectively. Each one of the wheeled carriages 64, 66 comprises a set of wheels 77, 79, see FIG. 4. More specifically, each one of the wheeled carriages 64, 66 is adapted to run inside one of the housings 32, 36 in the longitudinal direction of the guide rail arrangement 4, wherein the wheels 77, 79 engage with an inner surface of the housing.

The shading device 2 further comprises a first pair of arms 68, 70 associated to the first elongated support member 8, wherein the arms 68, 70 extend in a transverse direction relative to the longitudinal direction of the first elongated support member 8. A first end of each arm 68, 70 is connected to the first elongated support member 8 by means of a clip 69, 71 that partially surrounds the first elongated support member 8. A second end of each arm 68, 70 is connected to the engagement members 60, 62 via the first slot 34 and second slot 38, respectively, see also FIG. 4 and FIG. 5.

The shading device 2 further comprises a second pair of arms 72, 74 associated to the second elongated support member 10, wherein the arms 72, 74 extend in a transverse direction relative to the longitudinal direction of the second elongated support member 10. A first end of each arm 72, 74 is connected to the second elongated support member 10 by means of a clip 73, 75 that partially surrounds the second elongated support member 10. A second end of each arm 72, 74 is connected to the wheeled carriages 64, 66 via the first slot 34 and second slot 38, respectively. The further elongated support members 12, 14, 16, 18 are connected to their respective wheel carriages in a similar manner as has been described for the second elongated support member 10.

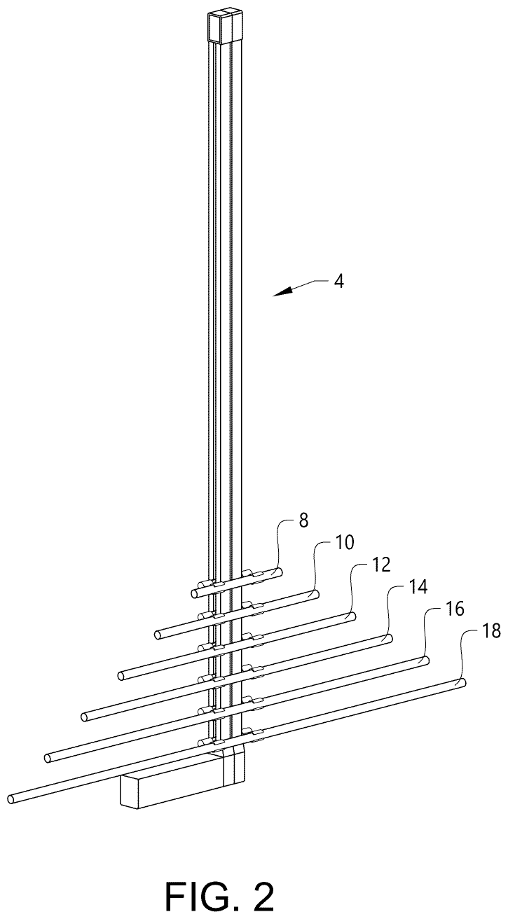

FIG. 2 discloses the shading device 2 in an assembled state without the extendable covering 6, wherein the elongated support members 8, 10, 12, 14, 16, 18 are in a close relationship adjacent a lower end of the guide rail arrangement 4. More specifically, the elongated support members 8, 10, 12, 14, 16, 18 are arranged with a first interspacing. More specifically, the elongated support members 8, 10, 12, 14, 16, 18 are evenly distributed in the longitudinal direction of the guide rail arrangement 4.

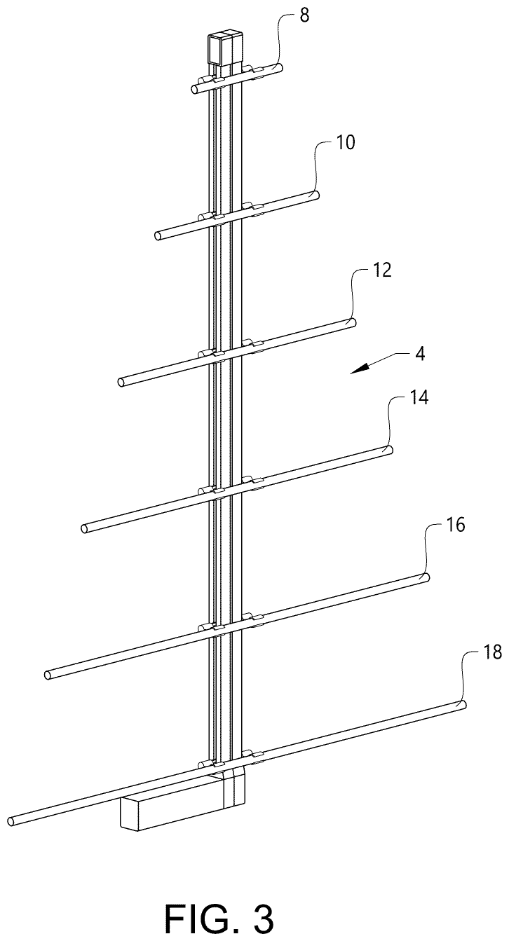

FIG. 3 discloses the shading device 2 in an assembled state without the extendable covering 6, wherein the elongated support members 8, 10, 12, 14, 16, 18 are in a distant relationship, wherein the first elongated support member 8 is adjacent a distant, upper end of the guide rail arrangement 4. More specifically, the elongated support members 8, 10, 12, 14, 16, 18 are arranged with a second interspacing, wherein the second interspacing is larger than the first interspacing. More specifically, the elongated support members 8, 10, 12, 14, 16, 18 are evenly distributed in the longitudinal direction of the guide rail arrangement 4.

FIG. 4 is a partly cut cross section view of the shading device 2 in FIG. 1. FIG. 5 is a partly cut perspective view of a first one 60 of the attachment means for attachment to the first endless elongated flexible element 52. It may be noted that the first continuous elongated flexible element 52 has an inner toothed surface and an outer generally flat surface. The first attachment means 60 comprises a recess with a shape and dimension corresponding to a cross section shape of the first endless elongated flexible element 52 for a form fit. Accordingly, the first attachment means 60 may be connected to the first endless elongated flexible element 52 in a fixed position so that it will follow the first endless elongated flexible element 52 as it is moved by the motor. Accordingly, the first attachment means 60 may be seen as a locomotive for moving the extendable covering 6 from its retracted state upwards towards its extended state since the first attachment means 60 will pull the wheeled carriages 64 by means of the extendable covering 6 forming a link between the first attachment means 60 and the uppermost wheeled carriage 64 and between the further wheeled carriages. On the other hand, gravity will support when moving the extendable covering 6 from its extended state downwards towards its retracted state and the first attachment means 60 will push the wheeled carriages 64 towards a close state.

In FIG. 4, two wheels 77, 79 of the wheeled carriage 64 are shown. The wheels 77, 79 are adapted to engage with an inner surface of the first housing. It may be noted that the housings 32, 36 are formed by profiles adapted with a dedicated space for the wheel carriages 64, 66.

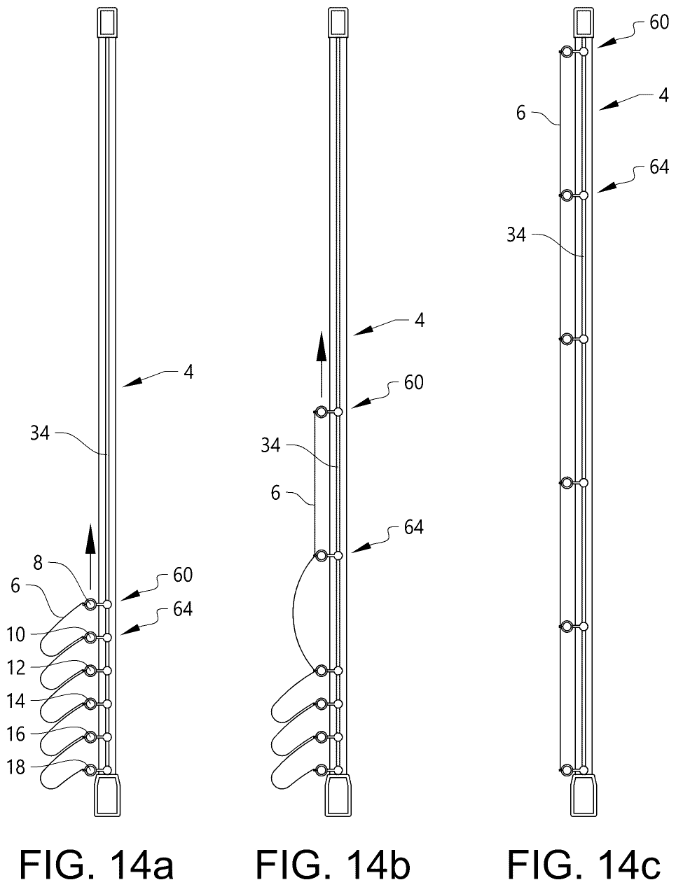

FIGS. 14a, 14b and 14c disclose the shading device 2 in FIG. 1 in side views with the extendable covering 6 in different extension states. FIG. 14a discloses the extendable covering 6 in a completely retracted state, wherein the elongated support members 8, 10, 12, 14, 16, 18 are in a close relationship adjacent a lower end of the guide rail arrangement 4 corresponding to FIG. 2. The extendable covering 6 forms a wavy structure. In other words, the fabric regions between two adjacent support members forms a bend. FIG. 14b discloses the extendable covering 6 in a partly extended state, wherein the motor 44 is rotating the drive wheels 48, 54 so that the continuous elongated flexible elements 52, 58 are moved, wherein the attachment means 60, 62 are moved longitudinally upwards along the guide rail arrangement 4 pulling the extendable covering 6 upwards. Due to the fact that the extendable covering 6 is attached to the second elongated support member 10, the wheeled carriages 64, 66 is pulled upwards running inside the respective guide rail 28, 30 as soon as the uppermost part of the extendable coverage 6 between the engagement members 60, 62 and the wheeled carriages 64, 66 reaches a flattened out state. FIG. 14c discloses the extendable covering 6 in a completely extended state, wherein the extendable covering 6 is completely flat extending in a vertical plane in parallel with the longitudinal direction of the guide rail arrangement 4.

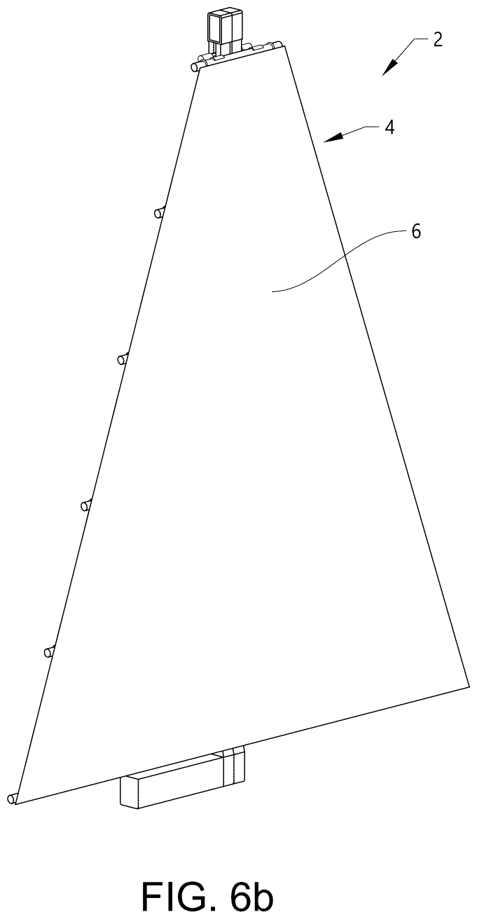

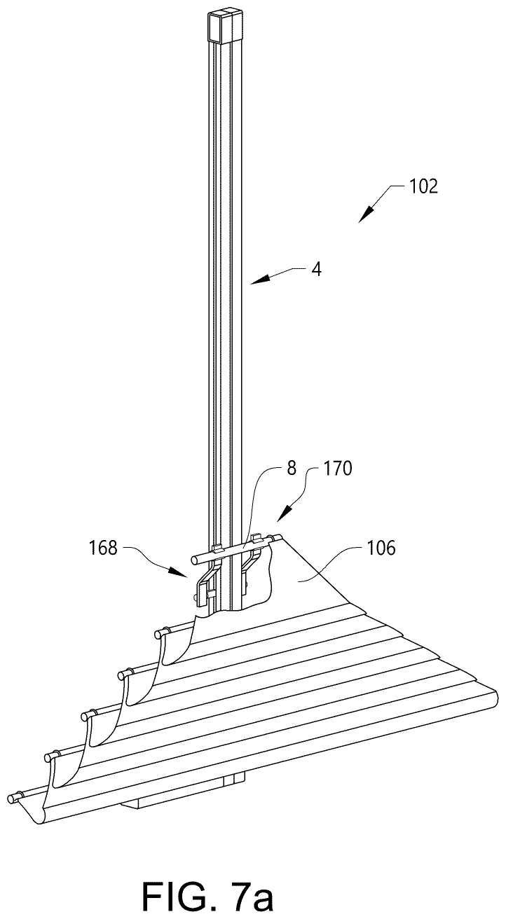

FIG. 6a is a perspective view of the shading device 2 in FIG. 1 with the extendable covering 6 in the retracted state corresponding to FIG. 2. FIG. 6b is a perspective view of the shading device 2 in FIG. 1 with the extendable covering 6 in the extended state corresponding to FIG. 3.

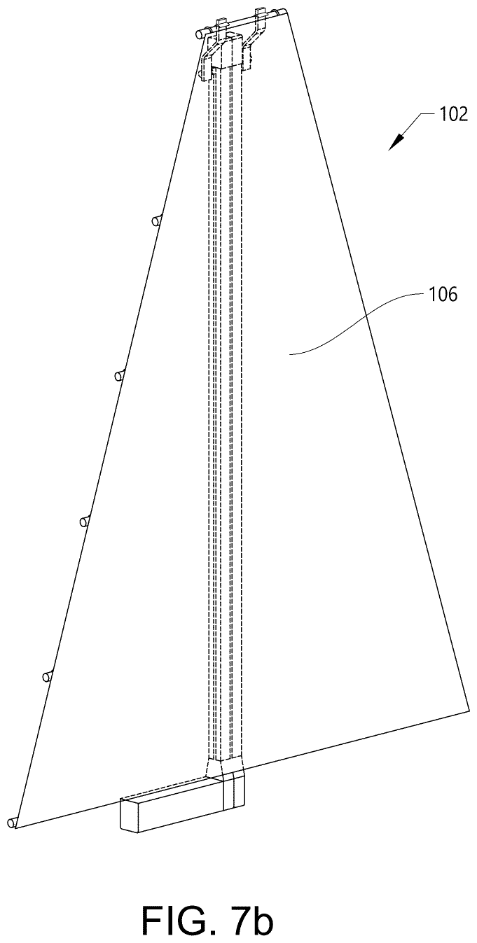

FIGS. 7a and 7b discloses a shading device 102 according to an alternative design relative to the shading device 2 in FIG. 1 with an extendable covering 106 in a retracted state and an extended state, respectively, corresponding to FIGS. 6a and 6b. For ease of presentation, only the main differences will be described. The shading device 102 comprises the guide rail arrangement 4 and the extendable covering 106. The first elongated support member 8 is arranged on an upwards extension 168, 170 that connects the first elongated support member 8 with the movement arrangement 20 and provides for that an upper end of the extendable covering 106 may cover an uppermost part of the guide rail arrangement 4 in the extended state, see FIG. 7b.

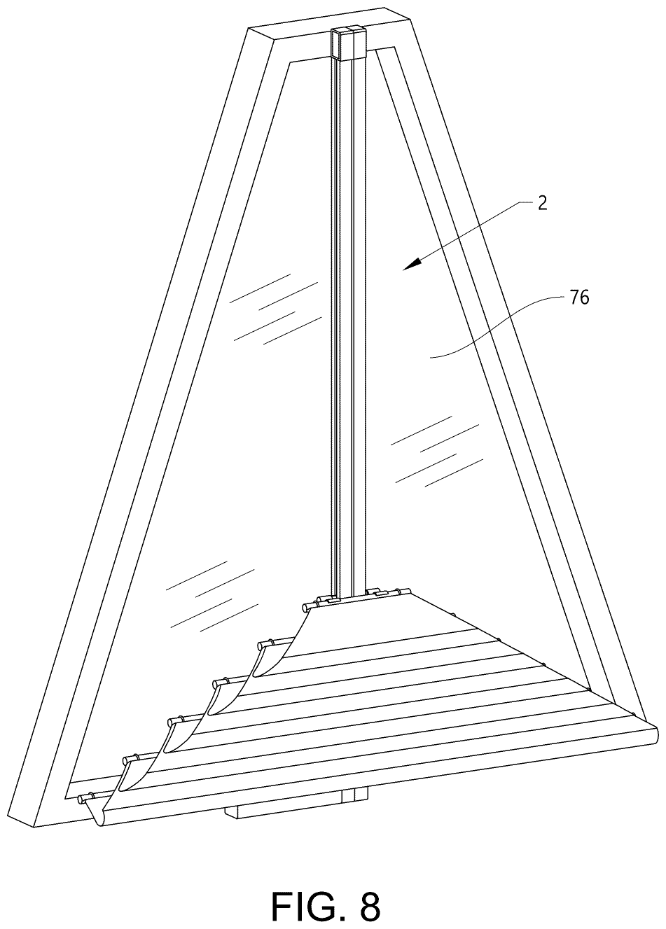

FIG. 8 is a perspective view of the shading device 2 in FIG. 1 associated to a window 76. The window 76 has a triangular shape that tapers upwards and extending in a vertical plane. The shading device 2 is adapted so that the extendable covering 6 may cover a complete surface of the window 76 in the extended state of the extendable covering 6.

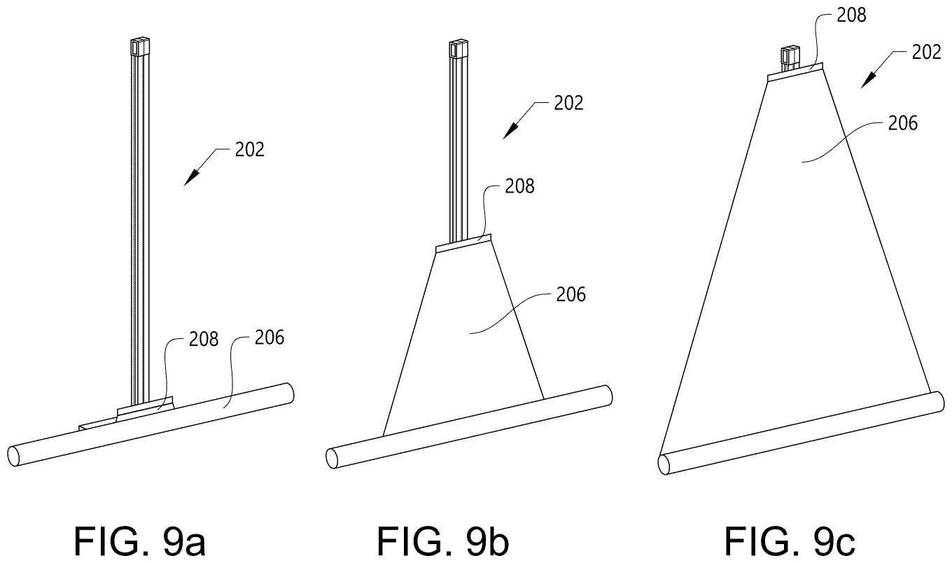

FIGS. 9a, 9b and 9c discloses a shading device 202 according to a further alternative design relative to the shading device 2 in FIG. 1 in different extension states. For ease of presentation, only the main differences will be described. The shading device 202 comprises an extendable covering 206 that is wound up on a roll and may be unwound from the roll. The shading device 202 comprises a single first elongated support member 208 arranged at a free end of the extendable covering 206 opposite the roll.

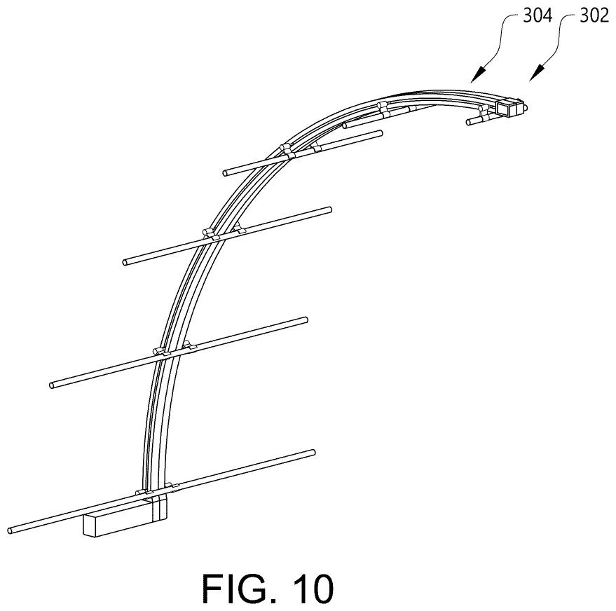

FIG. 10 discloses a further alternative design of a shading device 302, wherein the rail arrangement 304 has a curved shape and more particularly forms a single curve.

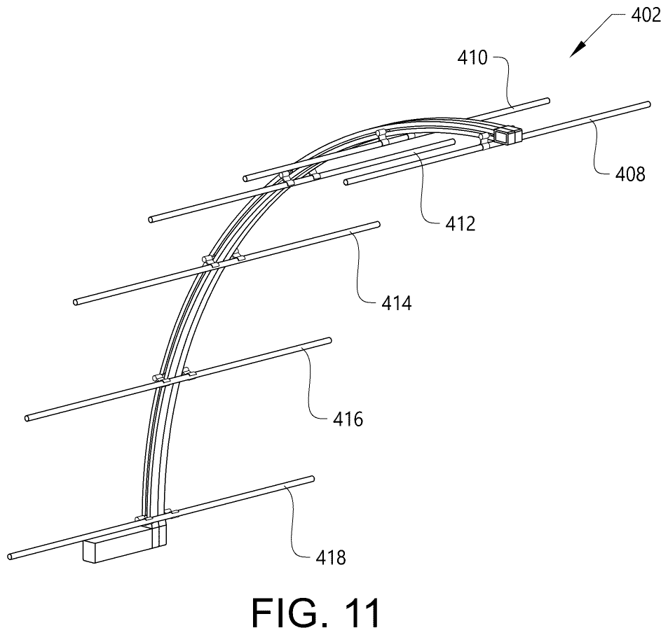

FIG. 11 discloses a further alternative design of a shading device 402 that is an alternative design of the shading device 302 in FIG. 10. The shading device 402 comprises a plurality of elongated support elements 408, 410, 412, 414, 416, 418 that are of equal lengths for covering a window with parallel lateral edges.

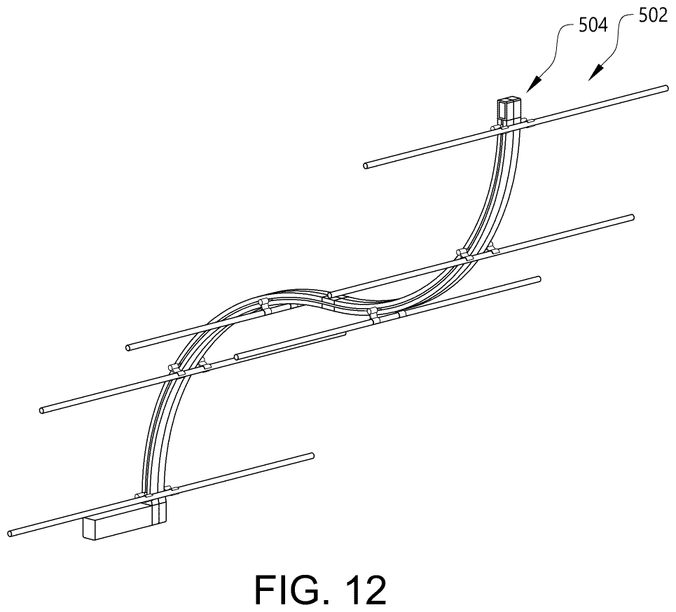

FIG. 12 discloses a further alternative design of a shading device 502 that is an alternative design of the shading device 402 in FIG. 11. The shading device 502 comprises a rail arrangement 504 that has a curved shape and more particularly forms a double curve. In other words, the rail arrangement 504 has a serpentine shape.

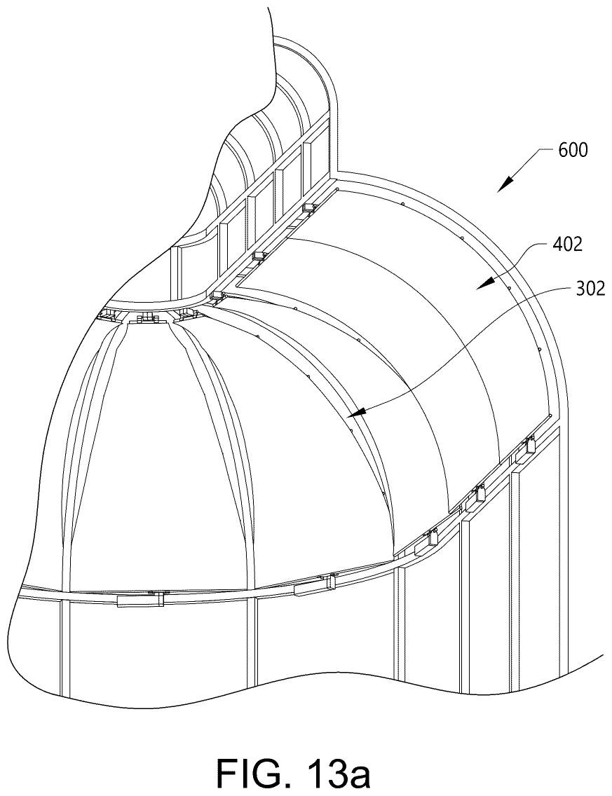

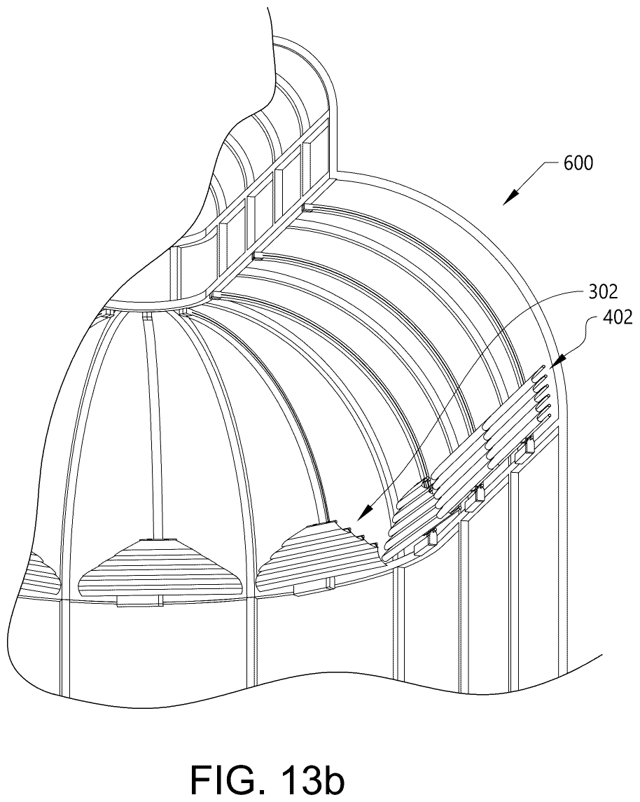

FIG. 13a is a partly cut perspective view of a building 600 in the form of a room with curved windows, that are convex outwards, wherein a plurality of shading devices 302, 402 according to the embodiments above are arranged to cover the windows. The shading devices are shown with their extendable coverings in an extended state. FIG. 13b is a partly cut perspective view of the building 600 in FIG. 13a, wherein the shading devices 302, 402 are shown with their extendable coverings in a retracted state.

It is to be understood that the present invention is not limited to the embodiments described above and illustrated in the drawings; rather, the skilled person will recognize that many changes and modifications may be made within the scope of the appended claims.

According to one alternative, the second rail in the rail arrangement may be of a different design and/or dimensions relative to the first rail.

According to one further alternative, the rail arrangement may comprise a single rail that presents two parallel slots facing in opposite directions. Accordingly, all attachment means and wheeled carriages may be arranged in one single housing.

Further, in the first embodiment described above, the extendable covering forms a link between the first attachment means and the uppermost wheeled carriage and between the further wheeled carriages for aiding in the extension of the extendable covering. According to one alternative or complement, a cord or similar may be arranged forming a link between the first attachment means and the uppermost wheeled carriage and between the further wheeled carriages for aiding in the extension of the extendable covering.

According to one further example, the extendable covering comprises a plurality of separate, interconnected and spaced parallel vane members. According to one example, the covering is formed by a so-called Venetian blind. The vane members are preferably of equal design and material. The vane members may alternatively be called blades or slats. According to one example, the vane members are substantially flat and rectangular with a main extension in a longitudinal direction and a secondary extension transverse direction relative to the longitudinal direction. Further, vane members are arranged in a spaced relationship on top of each other in the extension direction of the extendable covering. More specifically, the vane members are arranged so that their longitudinal direction is in a transverse direction of the extension direction of the extendable covering. According to one example, the vane members are substantially rigid. According to one example, the vane members are of plastic material. According to one alternative, the vane members are of wood or fiber material such as a lignocellulose-containing material. According to a further alternative, the vane members are of metallic material. The vane members may be interconnected by means of a cord. Further, the at least one elongated support member may be integrated in the plurality of separate, interconnected and spaced parallel vane members.

1. A shading device for being arranged in association to a window, wherein the shading device comprises
an elongated guide rail arrangement that is adapted to be stationarily arranged relative to the window,
an extendable covering,
at least one elongated support member, and
a movement arrangement,
wherein the extendable covering is supported by the at least one elongated support member,
wherein the at least one elongated support member is arranged to extend with its longitudinal direction in a transverse orientation relative to a longitudinal direction of the elongated guide rail arrangement and arranged to be movable along the elongated guide rail arrangement in the transverse orientation by the movement arrangement so that the extendable covering may be moved between a retracted state and an extended state for covering the window to different extents,
wherein the elongated guide rail arrangement comprises at least one housing defining at least one inner elongated chamber extending in the longitudinal direction of the elongated guide rail arrangement, a first slot and a second slot extending in the longitudinal direction of the elongated guide rail arrangement for forming a communication between one of the at least one inner elongated chamber and an outside of the elongated guide rail arrangement,
wherein the first slot faces in a first lateral direction of the elongated guide rail arrangement and the second slot faces in a second lateral direction of the elongated guide rail arrangement that is opposite the first lateral direction,
wherein the movement arrangement is at least partially arranged inside the at least one inner elongated chamber, and
wherein the at least one elongated support member is connected to the movement arrangement via said first slot and via said second slot.

2. The shading device according to claim 1, wherein the at least one elongated support member is arranged in the transverse orientation so that a first portion of the elongated support member is arranged on a first lateral side of the elongated guide rail arrangement and a second portion of the elongated support member is arranged on a second lateral side of the elongated guide rail arrangement.

3. The shading device according to claim 2, wherein the at least one elongated support member is connected to the elongated guide rail arrangement in a centre region of the elongated support member in its longitudinal direction in a way that the first portion and the second portion of the elongated support member are substantially of equal lengths.

4. The shading device according to claim 1, wherein the extendable covering is arranged symmetrically on either lateral side of the elongated guide rail arrangement.

5. The shading device according to claim 1, wherein the elongated guide rail arrangement comprises a first guide rail that comprises the first slot and a second guide rail that comprises the second slot, wherein the first guide rail and the second guide rail are arranged in parallel with each other.

6. The shading device according to claim 5, wherein the first guide rail and the second guide rail are arranged adjacent each other.

7. The shading device according to claim 5, wherein the first guide rail and the second guide rail are arranged rigidly attached to each other.

8. The shading device according to claim 1, wherein the shading device comprises a pair of arms associated to each one of the at least one elongated support member, wherein the arms extend in a transverse direction relative to the longitudinal direction of the elongated support member, wherein a first end of each arm is connected to the elongated support member and a second end of each arm is connected to the movement arrangement via the first slot and second slot, respectively.

9. The shading device according to claim 8, wherein the first end of each arm is connected to the at least one elongated support member by a clip that partially surrounds the at least one elongated support member.

10. The shading device according to claim 1, wherein the extendable covering comprises a sheet of fabric that is connected to the at least one elongated support member.

11. The shading device according to claim 1, wherein the at least one elongated support member is formed by a straight pin.

12. The shading device according to claim 1, wherein the shading device comprises a plurality of elongated support members, and wherein each one of the plurality of elongated support members is arranged to extend in the transverse orientation relative to the longitudinal direction of the elongated guide rail arrangement and arranged to be movable along the elongated guide rail arrangement in a way that their interspacing may be changed from a first interspacing when the extendable covering is in the retracted state to a second interspacing when the extendable covering is in the extended state, wherein the second interspacing is larger than the first interspacing.

13. The shading device according to claim 12, wherein at least two of said plurality of elongated support members have different lengths.

14. The shading device according to claim 12, wherein the extendable covering is connected to a plurality of the movably arranged elongated support members at a set spacing in an extension direction of the extendable covering so that the extendable covering may be arranged in a generally plane configuration when it is in extended end state and in a folded/undulating configuration when it is in a retracted end state.

15. The shading device according to claim 1, wherein the at least one housing comprises at least one wall portion that forms a front face and/or rear face of the guide rail arrangement, wherein the guide rail arrangement has a curved shape along at least one part of the guide rail arrangement in its longitudinal direction, wherein the movement arrangement comprises at least one elongated flexible element arranged in the inner elongated chamber of the housing and wherein the at least one elongated flexible element is adapted to be arranged in contact with an inner surface of the at least one wall portion in the curved part of the guide rail arrangement so that the elongated flexible element may slide along the inner surface during movement of the extendable covering between the retracted state and the extended state.

16. The shading device according to claim 15, wherein at least one elongated flexible element is formed by a continuous band that has a smooth outer surface for sliding in contact with the inner surface of the at least one wall portion in the curved part of the guide rail arrangement.

17. The shading device according to claim 1, wherein the movement arrangement comprises a drive motor, at least one pair of wheels and at least one elongated flexible element, wherein the wheels in said at least one pair of wheels are arranged spaced from each other in the longitudinal direction of the guide rail arrangement, wherein the elongated flexible element is arranged in a loop around the wheels in said at least one pair of wheels, wherein the drive motor is adapted to rotate at least one of the wheels, wherein the at least one movably arranged elongated support member is operationally connected to the elongated flexible element.
